(19) United States
(12) Patent Application Publication
(10) Pub. No.: US 2026/0138057 A1
(43) Pub. Date: May 21, 2026

(54) MULTI-ZONE FILTRATION DEVICE FOR A DOWN-FLOW HYDROPROCESSING REACTOR

(71) Applicant: Chevron U.S.A. Inc., San Ramon, CA (US)

(72) Inventors: Steven Xuqi SONG, Moraga, CA (US); Matthew D. POLAND, Oakland, CA (US); Matthew D. FORMEL, Long Beach, CA (US); Timothy D. EVANS, Moss Point, MS (US); David KASHEVAROFF, San Ramon, CA (US); James FRANCE, San Ramon, CA (US)

(21) Appl. No.: 19/122,998

(22) PCT Filed: Oct. 20, 2023
(86) PCT No.: PCT/US2023/077437

§ 371 Date: Apr. 21, 2025

Related U.S. Application Data
(60) Provisional application No. 63/418,189, filed on Oct. 21, 2022.

(51) Int. Cl. B01D 24/12; B01D 24/00; B01J 8/02; C10G 31/09; C10G 49/00

(52) U.S. Cl. CPC B01D 24/12; B01D 24/004; B01J 8/0242; B01J 8/0278; C10G 31/09; C10G 49/002

(57) ABSTRACT

A multi-zone filtration device for a down-flow catalytic hydroprocessing reactor is disclosed. The filtration device may be used in the petroleum and chemical processing industries in catalytic reactions of hydrocarbonaceous feedstocks in the presence of hydrogen, at an elevated temperature and pressure, to remove contaminants from mixed gas and liquid feedstreams to reactor catalyst beds. The filtration device may be provided as a horizontal installation at the top of a reactor, whereby feedstream liquid is passed through filtration media zones in a radial flow direction. In one zone, the flow is radially outward from the center of a zone of the filtration device to the wall of the reactor. In another zone, the flow is radially inward from the wall of the reactor to the center of a zone of the filtration device. The liquid flows to the reactor catalyst bed after passing through the filtration device. Among the benefits provided are the minimization of scale and small/fine particulates that reach the catalyst bed below the device, reduced pressure drop through the reactor, even when the filter is completely fouled, the potential for added catalyst volume due to the reduced need to use catalyst grading materials, and the improved potential for reduced maintenance needs during reactor operation, e.g., top bed skimming or filtration media replacement, thereby extending the reactor run time length.

### CROSS-REFERENCE TO RELATED APPLICATIONS

This application claims the benefit of priority to U.S. Provisional Patent Appl. Ser. No. 63/418,189, filed on Oct. 21, 2022, entitled “MULTI-ZONE FILTRATION DEVICE FOR A DOWN-FLOW HYDROPROCESSING REACTOR”, the disclosures of which are herein incorporated by reference in their entirety.

### FIELD OF THE INVENTION

A multi-zone filtration device for a down-flow catalytic hydroprocessing reactor is disclosed. The filtration device may be used in the petroleum and chemical processing industries in catalytic reactions of hydrocarbonaceous feedstocks in the presence of hydrogen, at an elevated temperature and pressure, to remove contaminants from mixed gas and liquid feedstreams to reactor catalyst beds.

### BACKGROUND OF THE INVENTION

In fixed-bed hydroprocessing reactors, gas and liquid reactants (e.g. hydrogen and a hydrocarbonaceous feedstock) flow downward through one or more beds of solid catalyst. (See, e.g., U.S. Pat. No. 4,597,854 to Penick). As the reactants flow downward through the reactor catalyst beds, the reactants contact the catalyst materials and react to produce the desired products. Reactor feedstreams may also contain foulants and contaminants, leading to unwanted deposits, including the formation of organic deposits such as gums.

Foulants carried in the liquid feedstream can cause fouling on the top distributor tray in a reactor and in the catalyst beds, leading to unwanted pressure drop increases that limit the performance of the reactor. Undesirable problems can result, including shorter run lengths, unplanned downtime, unused catalyst activity, non-uniform liquid distribution in catalyst bed, hot spot formation in the catalyst beds, and increased maintenance, such as distributor tray cleaning. Solutions to mitigate such problems include installing feed filters, bed grading, and, in some cases, filter trays above the top distributor tray.

Grading products have been used in some cases in the first catalyst bed for feed contamination removal. While such solutions generally show performance benefits, valuable reactor volume is taken away from the active catalyst volume thereby reducing the operating runtime and/or online performance. The use of grading beds also does not prevent fouling on the top distributor tray.

Feed filters may also be installed before the reactor inlet, and, in some cases, may be operated at lower temperatures than are used for the feedstream entering the reactor. When filtered liquid feed is subsequently mixed with hydrogen and heated in a furnace before flowing into the reactor inlet, additional organic deposits such as gum can be formed during this heating process after the feed filter. A means to remove sludge and contaminants in the reactor inlet header is therefore desirable to protect the top distributor tray and catalyst bed. A continuing need therefore exists for improvements in down-flow reactors, including devices for removing feedstream contaminants.

### SUMMARY OF THE INVENTION

The present invention is directed to a multi-zone filtration device for a down-flow hydroprocessing reactor. The device provides effective removal of contaminants from a liquid feedstream to a catalyst bed in a hydroprocessing reactor. The filtration device provides effective removal of fines and other contaminants, while minimizing the pressure drop through the device. The device is well-suited for retrofit applications and can be used for new reactor designs to achieve efficient feedstream contaminant removal so that reactor catalyst beds and reactor internals are not fouled and reactor operational performance is improved.

In addition to minimizing pressure drop through the filtration device during operation while contaminants are being removed, there is no or minimal additional pressure drop through the device once the filtration media has become completely fouled, i.e., filled with removed contaminants.

The multi-zone filtration device generally includes a first filtration zone and a second filtration zone. The first zone includes a top cover having inner and outer surfaces, a top cover periphery, and a top cover aperture; a liquid impervious base plate generally parallel to the top cover having inner and outer surfaces, a base plate periphery, a base plate aperture, and a removable base plate aperture cover; a first zone containment barrier; optionally, a base plate aperture containment barrier; a support structure for the top cover; and filtration media contained within a first zone filtration media volume on top of the base plate. The top cover and base plate are separated by a distance to define an interior volume of the first zone of the filtration device, such that the interior volume comprises a filtration media volume located on top of and adjacent to the base plate inner surface. The first zone containment barrier retains filtration media on the base plate, and is generally located around the perimeter of the base plate and extends from the base plate to the top of the filtration media volume or to the bottom surface of the top cover. The first zone base plate aperture containment barrier, when present, retains filtration media within the first zone filtration media volume on the base plate, and is generally located around the perimeter of the base plate aperture and extends from the base plate to the top of the filtration media volume or to the bottom surface of the top cover. The support structure for the first zone top cover is generally positioned within the interior volume of the filtration device and comprises one or more supports to provide and maintain the separation distance between the top cover and the base plate. The base plate and the top cover of the first zone, and the top cover and base plate apertures, are centrally located about the same central perpendicular axis. The top cover and the bottom plate have substantially the same areal dimension so that feedstream liquid can flow into the first zone of the filtration device through the top cover and/or through first zone base plate aperture containment barrier. The base plate aperture cover is sized and configured to prevent liquid flow through the first zone base plate aperture when installed in and during operation of a down-flow reactor.

The second zone includes a top cover having inner and outer surfaces, a top cover periphery, a top cover aperture, and a removable top cover aperture cover; a liquid impervious base plate generally parallel to the top cover having inner and outer surfaces, a base plate periphery, and a base plate aperture; a base plate aperture containment barrier; a support structure for the top cover; a separator on top of filtration media; and filtration media contained within a second zone filtration media volume on top of the base plate. The second zone top cover and base plate are separated by a distance to define an interior volume of the second zone of the filtration device, such that the interior volume comprises a filtration media volume located on top of and adjacent to the base plate inner surface and a flow bypass volume located on top of the filtration media volume and adjacent to the top cover inner surface. The second zone base plate aperture containment barrier retains filtration media within the second zone filtration media volume on the base plate, and is generally located around the perimeter of the base plate aperture and extends from the base plate to the top of the filtration media volume or to the bottom surface of the top cover. The support structure for the second zone top cover is generally positioned within the interior volume of the filtration device and comprises one or more supports to provide and maintain the separation distance between the top cover and the base plate. The separator is positioned between the filtration media volume and the flow bypass volume. The separator is generally a thin, porous material that is parallel to both the top cover and the bottom plate. The separator contains the filter media within the filtration media volume, and allows liquid to flow into the filtration media volume. The base plate, the top cover, the separator, and the top cover and base plate apertures of the second zone are centrally located about the same central perpendicular axis as in the first zone. The separator generally has substantially the same areal dimension as the bottom plate. The top cover has a smaller areal dimension than the bottom plate so that feedstream liquid and gas can flow into the second zone inlet between the periphery of the second zone top cover and the periphery of the base plate. The top cover aperture cover is sized to prevent liquid flow through the top cover aperture when installed in and during operation of a down-flow reactor.

In general, the base plate and the top cover of the first and second zones, and the separator of the second zone, are centrally positioned about the same central perpendicular axis. The first zone top cover and the bottom plate having substantially the same areal dimension so that feedstream liquid can flow into the first zone of the filtration device through the top cover and/or through the first zone base plate aperture containment barrier. In the second zone, the separator generally has the same areal dimension as the second zone bottom plate. The second zone top cover generally has a smaller areal dimension than the bottom plate so that feedstream liquid and gas can flow into the filtration device inlet between the periphery of the top cover and the periphery of the base plate.

The invention also relates to a down-flow hydroprocessing reactor comprising the multi-zone filtration device and to a process for removing contaminants from a liquid feedstream in such a reactor. The process generally comprises passing a feedstream containing liquid and gas to a down-flow catalytic hydroprocessing reactor through the filtration device installed at the top of the reactor, wherein the liquid components of the feedstream are routed through the filtration media contained within the filtration media volume of the first zone and through the filtration media contained within the filtration media volume of the second zone of the filtration device. The feedstream liquid passes through the filtration media contained within the filtration media volumes of the first and second zones, while the feedstream gas passes through the flow bypass volume of the second zone of the filtration device.

### BRIEF DESCRIPTION OF THE DRAWINGS

FIGS. 1-11 provide representative views of a multi-zone filtration device according to one or more embodiments of the invention. The scope of the invention is not limited by these representative figures and is to be understood to be defined by the appended claims.

FIG. 1 shows a side view of an embodiment of the first zone of the filtration device of the invention.

FIG. 2 shows a side view of an embodiment of the second zone of the filtration device of the invention.

FIG. 3 shows a side view of an embodiment of a dual zone filtration device of the invention installed in the top of a reactor, with the side cross-section of the reactor wall and an existing distribution tray (also referred to herein as a perforated tray) also shown.

FIG. 4 shows the same view of a dual zone filtration device as in FIG. 2 with the flow paths of feedstream liquid and gas also shown.

FIG. 5 shows a ¾ quarter cutout view of the lower section of the second zone of the filtration device with the top cover and separator removed (also showing an existing tray below the filtration device).

FIG. 6 shows a ¾ quarter cutout view of the second zone of the filtration device as in FIG. 5 with the separator in place.

FIG. 7 shows a ¾ quarter cutout view of the second zone of the filtration device as in FIG. 6 with the top cover in place.

FIG. 8 shows a ¾ quarter cutout view of a dual zone filtration device showing an open view of the top first zone (circular manway opening) with the top cover removed and the lower second zone of the filtration device.

FIG. 9 shows a ¾ quarter cutout view of a dual zone filtration device showing a view of the top first zone (circular manway opening) with the top cover installed and the lower second zone of the filtration device.

FIG. 10 shows a ¾ quarter cutout view of a dual zone filtration device showing an open view of the top first zone (rectangular manway opening) with the top cover removed and the lower second zone of the filtration device.

FIG. 11 shows a ¾ quarter cutout view of a dual zone filtration device showing a view of the top first zone (rectangular manway opening) with the top cover installed and the lower second zone of the filtration device.

### DETAILED DESCRIPTION

Specific embodiments and benefits are apparent from the detailed description provided herein. It should be understood, however, that the detailed description, figures, and any specific examples, while indicating beneficial embodiments, including some that are preferred, are intended for purposes of illustration only and are not intended to limit the scope of the invention.

The invention is directed to a multi-zone filtration device for a down-flow hydroprocessing reactor. The device comprises a first filtration zone and a second filtration zone. The first zone comprises a top cover with inner and outer surfaces, a top cover periphery, and a top cover aperture; a base plate generally parallel to the top cover having inner and outer surfaces, a base plate periphery, a base plate aperture, and a removable base plate aperture cover; a first zone containment barrier; optionally, a base plate aperture containment barrier; a support structure for the top cover; and filtration media contained within a first zone filtration media volume of the device and on top of the base plate. The second zone comprises a top cover having inner and outer surfaces, a top cover periphery, a top cover aperture, and a removable top cover aperture cover; a liquid impervious base plate generally parallel to the top cover having inner and outer surfaces, a base plate periphery, and a base plate aperture; a base plate aperture containment barrier; a support structure for the top cover; a separator on top of filtration media; and filtration media contained within a second zone filtration media volume on top of the base plate.

The first zone top cover and base plate are separated by a distance defining an interior volume of the first zone of the filtration device, such that the interior volume comprises a filtration media volume located on top of and adjacent to the base plate inner surface. The first zone containment barrier retains filtration media on the base plate. The containment barrier is generally located around the perimeter of the base plate and extends from the base plate to the top of the filtration media volume or to the bottom surface of the top cover and retains filtration media in the first zone filtration media volume on the base plate. The first zone base plate aperture containment barrier, when present, also retains filtration media within the first zone filtration media volume on the base plate. The aperture containment barrier is generally located around the perimeter of the base plate aperture and extends from the base plate to the top of the filtration media volume or to the bottom surface of the top cover. The support structure for the first zone top cover is located within the interior volume of the filtration device and comprises one or more supports to provide and maintain the separation distance between the top cover and the base plate. The base plate and the top cover of the first zone, and the top cover and base plate apertures, are centrally located about the same central perpendicular axis. The top cover and the bottom plate have substantially the same areal dimension so that feedstream liquid can flow into the first zone of the filtration device through the top cover and/or through the first zone base plate aperture containment barrier. The base plate aperture cover is sized and configured to prevent liquid flow through the first zone base plate aperture when installed in and during operation of a down-flow reactor.

The second zone top cover and base plate are separated by a distance defining an interior volume of the filtration device. The second zone interior volume comprises a filtration media volume located on top of and adjacent to the base plate inner surface and a flow bypass volume located on top of the filtration media volume and adjacent to the top cover inner surface. The base plate aperture containment barrier retains filtration media within the second zone filtration media volume on the base plate. The base plate aperture containment barrier is generally located around the perimeter of the base plate aperture and extends from the base plate to the top of the filtration media volume or the bottom surface of the top cover. The support structure for the top cover is located within the interior volume of the filtration device and comprises one or more supports to provide and maintain the separation distance between the top cover and the base plate. The separator is positioned between the filtration media volume and the flow bypass volume. The separator is generally a thin, porous material that is parallel to both the top cover and the bottom plate. The separator contains the filter media within the filtration media volume, and allows liquid to flow into the filtration media volume. The base plate, the top cover, the separator, and the top cover and base plate apertures of the second zone are centrally located about the same central perpendicular axis as in the first zone. The separator generally has substantially the same areal dimension as the bottom plate. The second zone top cover has a smaller areal dimension than the bottom plate so that feedstream liquid and gas can flow into the second zone inlet between the periphery of the second zone top cover and the periphery of the base plate. The second zone top cover aperture cover is sized to prevent liquid flow through the top cover aperture when installed in and during operation of a down-flow reactor.

The first and second zone containment barrier and aperture containment barrier may generally be liquid permeable throughout the width and height of the barrier. In some embodiments, the containment barrier may be liquid permeable in a portion of the width and/or height of the barrier while liquid impermeable (or liquid permeable to a lesser degree) to allow liquid to be retained within either or both of the first and second zone filtration volumes. The device does not need or necessarily include an outer perimeter second zone containment barrier located around the perimeter of the base plate extending from the base plate to the top of the filtration media volume or the bottom surface of the top cover. The filtration media need not be contained around the perimeter of the second zone base plate through the use of an outer perimeter containment element.

In general, the base plate, the top cover, and the separator of the second zone are centrally positioned about the same central perpendicular axis. The separator generally has the same areal dimension as the base plate. The second zone top cover also generally has a smaller areal dimension than the bottom plate so that feedstream liquid and gas can flow into the filtration device inlet between the periphery of the top cover and the periphery of the base plate. While the filtration device is not necessarily limited to a particular shape or dimensions, in most cases the device will match the cross-sectional shape of a new or existing reactor; typically, the filtration device is circular in shape such that each of the top cover, the base plate, and the separator are circular and dimensioned to correspond to the internal dimensions of a reactor and to fit horizontally within the top space of the reactor. In cases where the device is generally circular, the distance between the outer perimeter of the top cover (also referred to herein as the top flow diverter plate) and the outer perimeter of the base plate is an annular area around the outside of the second zone through which feedstream liquid and gas that has been diverted to the outside of the reactor enters the second zone of the device and flows inward toward the base plate aperture.

The top cover and the base plate of the first and second zones, and the separator of the second zone, may also be formed as a plurality of sections that together form the respective top cover, the base plate, or the separator. The use of sections for certain device components like the top cover, base plate and the separator allows sections to be placed within or to be removed from the reactor through a reactor internal access location, such as a manway, thereby facilitating installation and maintenance.

Various support structures may be used to support the first and/or second zone top cover, or sections of the top cover, and provide a distance between the top cover and the base plate. For example, a plurality of cross members, such as trusses, that span the sectional distance between the walls of the reactor may be used to support the top cover of the second zone. The support structures, or more particularly the cross members, will typically be supported by structures within the reactor, such as by a supporting member that rests on top of an existing tray or through other connections to the reactor or reactor internals. In some cases, e.g., when cross members are used, the support structure may also be used to support the separator or sections of the separator. The support structures may also support the base plate or sections of the base plate. In one embodiment, the support structures comprise a plurality of cross member trusses that span the distance from one reactor wall to the other side of the reactor across a section of the reactor cross-section such that the base plate is supported on the lower portion of the truss, the separator is supported on an intermediate portion of the truss, and the top cover is supported by the top of the truss. In the case where each of the top cover, base plate, and separator comprise sections of the respective component, each section may be configured and arranged to be supported within the spaces between the trusses.

In general, the filtration device may use any arrangement of first and second zones, or any number of zones, within the device. As a practical matter, however, the height available at the top of a down-flow reactor may limit the device to two or three zones. In one embodiment, e.g., a first zone and a second zone may be arranged in a dual zone configuration with the first zone positioned on top of the second zone.

Depending on the arrangement of the first and second zones, one zone may be stacked on top of another to thereby rely on supporting trusses used for a bottom zone to also support one or more upper zones. For example, in an embodiment wherein the filtration device is a dual zone device having one first zone located on top of one second zone, supporting trusses may be used for the bottom second zone. The upper first zone may then make use of the support provided by the second zone so that the interior supports needed for the first zone may benefit from reduced loading requirements.

The separator of the second zone generally defines the area between the filtration media volume and the bypass flow volume within the second zone of the filtration device. Typically, the separator is a thin, porous material that functions to hold the filtration media in place and within the filtration media volume. Various materials may be used, such as those that are wire based, as well as grid, mesh, screen, or perforated metals or plates. While not particularly limited, the separator, or sections thereof, may be somewhat rigid to aid in installation and to help maintain their placement during operation. In some embodiments, the separator may be an optional component, and may not necessarily be included in the device, e.g., if the separator is not required for the filtration media to remain contained within the filtration media volume.

The base plate aperture of the second zone allows for feedstream liquid and gas to pass through the filtration device and flow to other down locations in the device or the reactor, e.g., to a distributor tray below the filtration device. The size of the aperture may vary and is not particularly limited (other than to avoid introducing a flow restriction and to allow for efficient use of the filtration volume). The base plate aperture may be shaped to provide manway access to reactor internals below the filtration device.

The aperture covers for the first zone base plate and the second zone top cover may be formed from various materials, including those used for the respective plates. While not limited thereto, the covers are typically made of a liquid impervious material, such as the same metal used for the plates. The covers are generally removable to allow access to the inside of the filtration device and to allow manway access to reactors internals within a down-flow reactor.

Various filtration media may be used to provide contaminant removal within the first zone and second zone filtration volumes. While suitable materials generally include any known in the art, typically an absorbent material that is convenient to load, maintain and remove will be used. Such materials are commercially available and are typically provided in pellet or other usual shapes for hydroprocessing reactors. In some cases, a pellet shaped absorbent filtration media having a nominal length in the range of about 5 mm to about 20 mm may be useful. The filtration media used in the first and second zones may be the same or different, and is generally selected according to the filtration needs for each zone.

The invention further relates to the use of the filtration device in a hydroprocessing system and to hydroprocessing reactor systems that use the filtration device. In particular embodiments, the filtration device may be advantageously used in a down-flow hydroprocessing reactor, e.g., as a contaminant removal tray located internally at the top of such reactors.

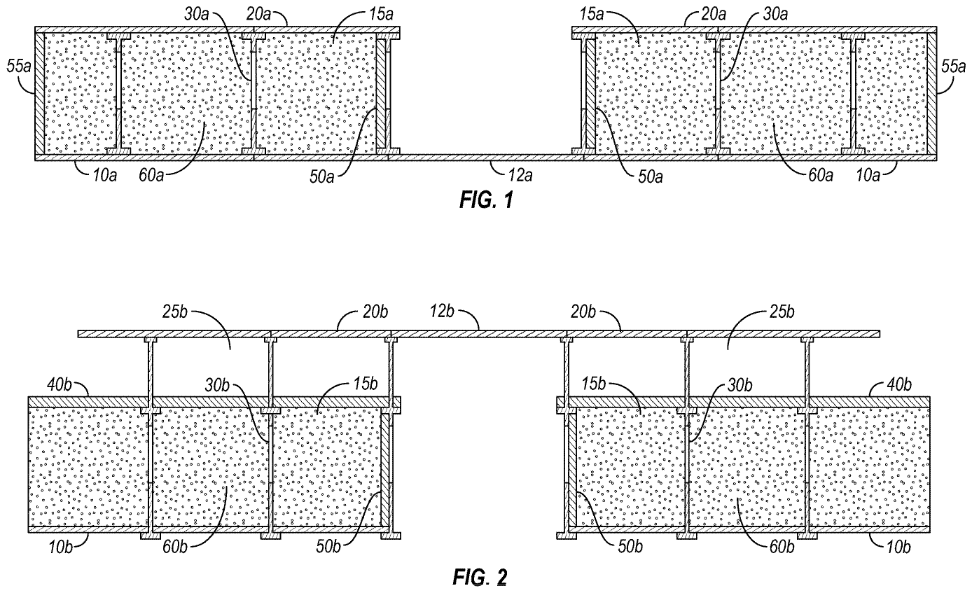

In embodiments of the invention, as represented by FIGS. 1 to 11, a filtration device may have a central cross-sectional view as shown for the first zone in FIG. 1 and the second zone in FIG. 2. In FIG. 1, the first zone base plate 10a forms the lower part of the first zone of the filtration device with the top formed by the first zone top cover 20a. The base plate 10a has an opening referred to as the base plate aperture that is generally centrally located on the base plate to allow manway access through the device, e.g., to a distribution tray below the filtration device. As shown in FIG. 1, a base plate aperture cover 12a is installed in or over the aperture during normal down-flow reactor operation. Supports or cross members, which may be trusses 30a, are shown to support the base plate and the top cover. The filtration volume 15a (first zone) is located between base plate 10a and top cover 20a and is also located between the cross members 30a (also referred to as supports, support members, and trusses herein). The supports may be of any suitable arrangement or structure to support the top cover. The containment barrier 55a is located at the outer edge periphery of the base plate and around the perimeter to contain the filtration media on the base plate. The aperture containment barrier 50a surrounds the base plate aperture in the interior or center of the filtration device. Filtration media 60a is contained within the first zone filtration media volume 15a. The top cover 20a may also have an opening (as shown) generally corresponding to the base plate aperture to allow access to the interior of the filtration device. Although not required, the base plate 10a and the top cover 20a may be each provided in the form of more than one section(s) that are located on top of and between the supports 30a. In some cases, one or more of the base plate 10a and the top cover 20a may be provided as non-sectioned, whole components of the filtration device.

In FIG. 2, the second zone base plate 10b forms the lower part of the second zone of the filtration device with the top formed by the second zone top cover 20b. The base plate 10b has an opening referred to as the base plate aperture that is generally centrally located on the base plate to allow manway access through the device, e.g., to a distribution tray below the filtration device. As shown in FIG. 2, a top cover aperture cover 12b is installed in or over the aperture during normal down-flow reactor operation. Supports or cross members, which may be trusses 30b, are shown to support the base plate and the top cover. The separator 40b, located between the lower (second zone) filtration volume 15b and the upper flow bypass volume 25b, separates the interior volume of the second zone into two flow sections and is also supported by the cross members 30b (also referred to as supports, support members, and trusses herein). The filtration volume 15b is located between base plate 10b and top cover 20b and is also located between the cross members 30b. The supports may be of any suitable arrangement or structure to support the top cover. The aperture containment barrier 50b surrounds the base plate aperture in the interior or center of the filtration device. Filtration media 60b is contained within the filtration media volume 15b. The top cover 20b may also have an opening generally corresponding to the base plate aperture to allow access to the interior of the filtration device. Although not required, the base plate 10b and the top cover 20b may each be provided in the form of more than one section(s) that are located on top of and between the supports 30b. In some cases, one or more of the base plate 10b and the top cover 20b may be provided as non-sectioned, whole components of the filtration device.

In one embodiment, the first zone and the second zone may be combined in a dual zone filtration device with the first zone directly on top of the second zone. In such an arrangement only one of the base plate of the first zone and the top cover of the second zone need be used. For example, the base plate aperture cover 12a of the first zone and the top cover aperture cover 12b can be simplified, depending on the configuration and assembly, to use only one aperture cover rather than both.

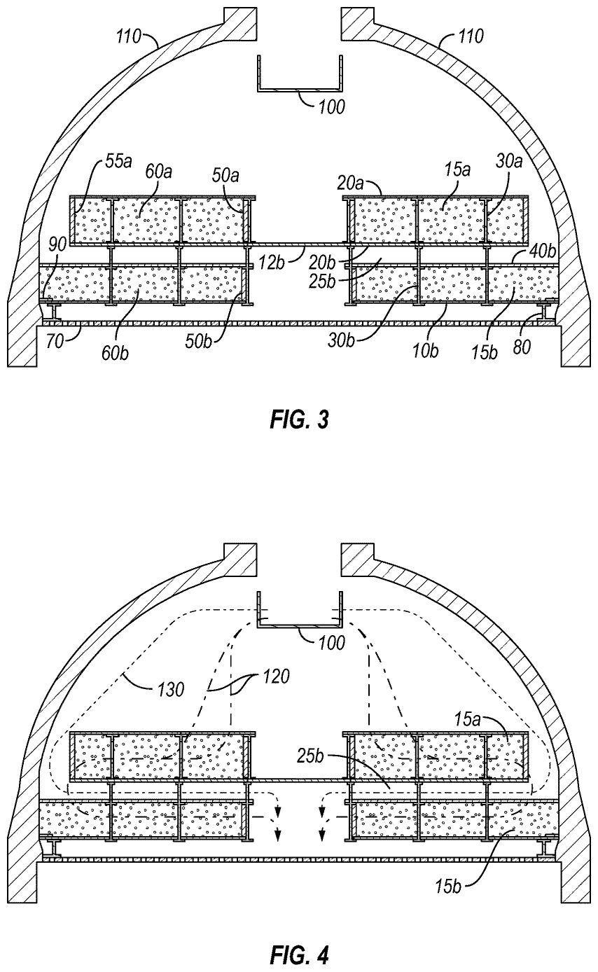

FIG. 3 shows the same central cross-sectional view as FIGS. 1 and 2 in an embodiment where a dual zone filtration device is installed in a down-flow reactor. Feature reference numbers described in FIGS. 1 and 2 apply to FIG. 3. As shown, the filtration device may be installed at the top of the reactor and positioned between the side walls of the reactor shell 110 and below a catch basin 100, e.g., if one is present. While FIG. 3 shows one embodiment of a possible installation of the device within a down-flow reactor, other configurations may be used. Second zone top cover 20b and aperture cover 12b are shown where the top cover is used in place of the base plate 10a of the first zone. Other elements identified in the foregoing description of FIGS. 1 and 2 are also shown in FIG. 3 and are incorporated herein for reference and completeness. Also included in FIG. 3 for illustration purposes are a distribution tray (also referred to as a perforated tray) 70, a spacer ring 80 positioned between the distribution tray 70 and the base plate 10, and a seal ring 90 to provide a seal between the base plate and the reactor side wall. Distribution tray 70, spacer ring 80, and seal ring 90 are not required components of the filtration device or of the installation of the device within a reactor and are provided herein to illustrate a possible installation embodiment.

FIG. 4, shows the same central cross-sectional view as FIG. 3 in an embodiment where a dual zone filtration device is installed in a down-flow reactor below a catch basin 100 to illustrate a simplified view of the general liquid and gas flow paths. Liquid 120 and gas 130 flow pathways are generally shown through the first zone filtration media 15a, the second zone filtration media 15b, and the flow bypass volume 25b within the filtration media volume of the second zone, respectively. As shown, the flow of feedstream liquid is radially outward in the first zone and radially inward in the second zone from the reactor side wall, passing through the second zone filtration device inlet and the second zone filtration media volume and then through the containment barrier and the base plate aperture located in the center of the filtration device.

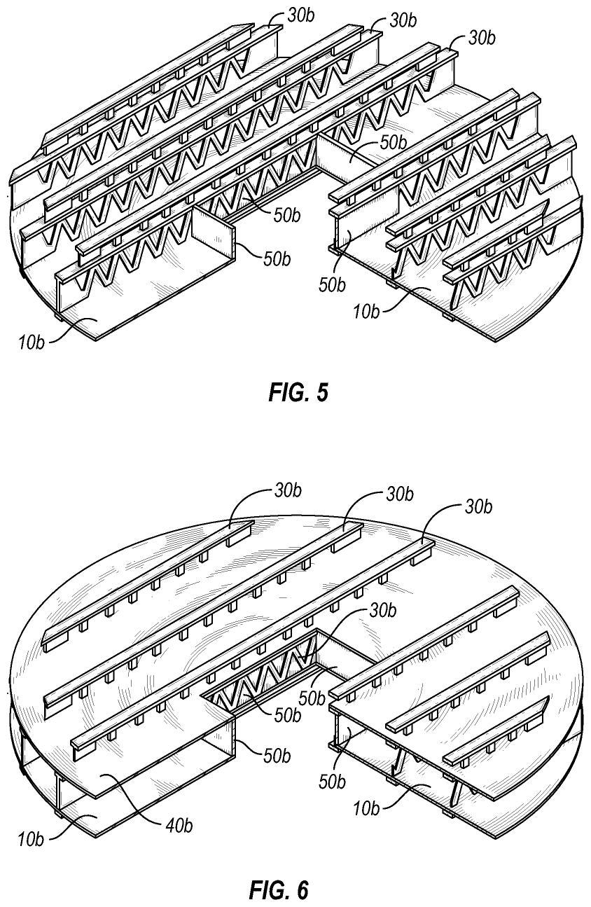

FIG. 5 shows a ¾ sectional isometric view of an embodiment of the second zone of the filtration device with the top cover and the separator removed so that the internal arrangement of the cross member 30b supports and the containment barrier 50b may be easily seen. As shown, the base plate aperture located in the center of the base plate 10b provides manway access to the reactor internals below the filtration device. While cross members 30b are shown as truss supports, suitable alternative supporting members may be used.

FIG. 6 shows a ¾ sectional isometric view according to FIG. 5 with the second zone separator 40b installed (also referred to as hold down screens) and supported at intermediate positions on the cross members 30b. The separator generally has the same areal dimension as the base plate and contains a central opening aperture that corresponds to the opening of the base plate aperture. Also shown are the top supports of the cross members 30b that support the top cover when installed.

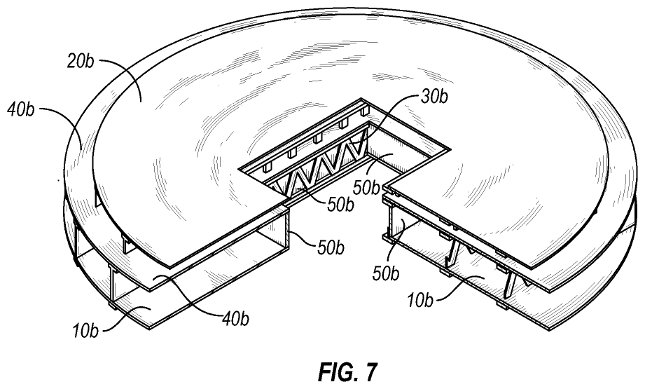

FIG. 7 shows a ¾ sectional isometric view according to FIGS. 5 and 6 with the top cover 20 b installed (also referred to as a deflector tray) and supported at the top of the cross members 30b. Top cover 20b is shown with the aperture cover (central manway panel) removed. The aperture cover (12a in FIG. 1 or 12b in FIG. 2, also referred to as a manway panel) is installed for normal reactor operation and may be removed for service access. Other components are also shown as in FIGS. 4 and 5 for reference, including, e.g., second zone separator 40b.

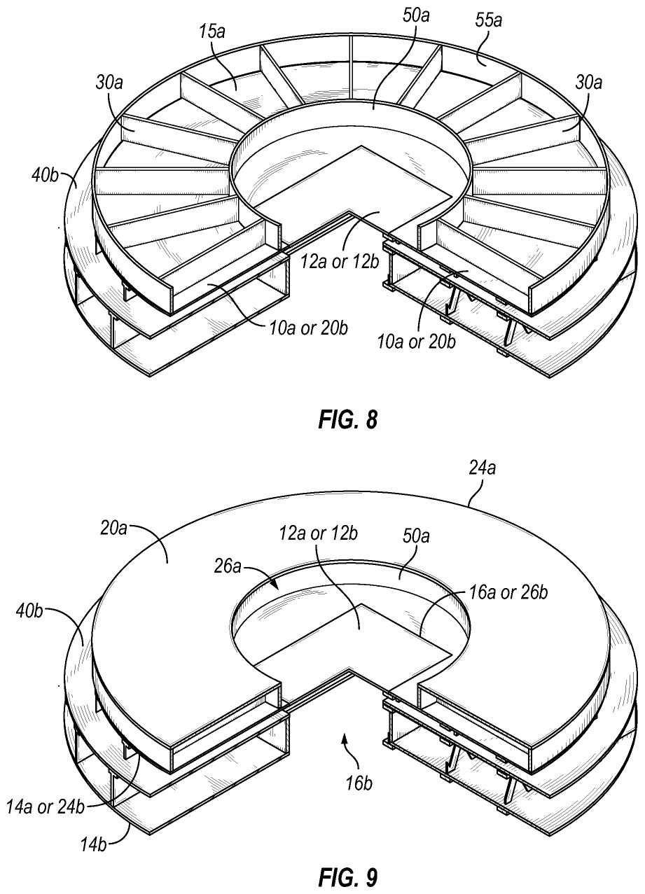

FIG. 8 illustrates a ¾ sectional isometric view with support members 30a of the first zone installed on top of the top cover 20b of the second zone, which serves as the base plate for the first zone. Note that base plate 10a of the first zone in FIG. 1 and top cover 20b of the second zone in FIG. 2 may both be used for the first and second zones, respectively, or either base plate 10a or top cover 20b may be used individually, rather than both. The perimeter containment barrier 55a and the interior aperture containment barrier 50a are also shown. The top cover aperture cover (manway panel) 12b is shown in the center of the first zone aligned with the manway access in the second zone (i.e., the second zone aperture). Note that aperture cover 12a as shown in FIG. 1 may also be used together or in place of aperture cover 12b as shown in FIG. 2. Sections of the first zone filtration volume 15a and the second zone separator 40b are also shown.

FIG. 9 shows the view according to FIG. 8 with the first zone top cover 20 a installed. FIGS. 8 and 9 depict a circular central aperture manway access area bounded by aperture containment barrier 50a. Also shown for the first zone are the first zone aperture cover 12a (which, as shown may be the same as the second zone top cover aperture cover 12b), base plate periphery 14a, base plate aperture 16a, top cover periphery 24a, and top cover aperture 26a, and, for the second zone, base plate periphery 14b, base plate aperture 16b, top cover periphery 24b (which, as shown, may be the same as the first zone base plate periphery 14a), top cover aperture 26b (which, as shown, may be the same as the first zone base plate aperture 16a), and top cover aperture cover 12b (which, as shown, may be the same as the first zone aperture cover 12a). Second zone separator 40b is also shown.

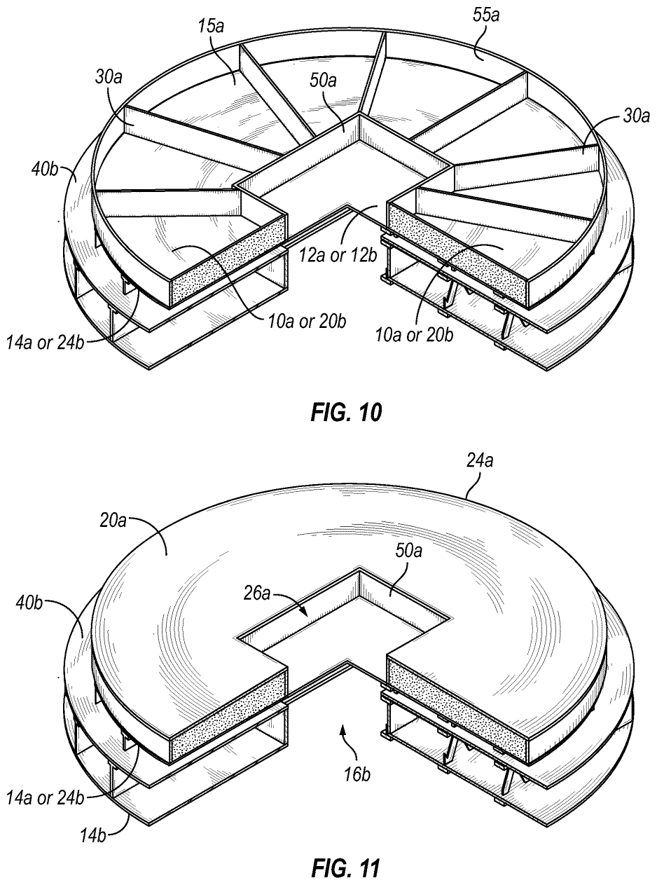

FIGS. 10 and 11 show views and first zone components that correspond to FIGS. 8-9 but with a rectangular central aperture manway access area extending through the first zone top cover 20a with containment barrier 50a surrounding the manway access aperture. Certain features identified in FIGS. 1-9, and described hereinabove, are also incorporated herein for reference and completeness, including first zone base plate 10a, (which may be the same as second zone top cover 20b), first zone aperture cover 12a (which, as shown may be the same as the second zone top cover aperture cover 12b), first zone base plate periphery 14a (which, as shown, may be the same as the second zone top cover periphery 24b), top cover periphery 24a, and support members 30a. Sections of the first zone filtration volume 15a (FIG. 10) and the second zone separator 40b are also shown. FIG. 11 shows top cover aperture 26a and base plate aperture 16b as in FIG. 9.

The multi-zone filtration device of the invention, including the specific embodiments described herein, provides certain benefits and improvements in hydroprocessing applications, including: the minimization of scale and small particles or fines from reaching the catalyst bed(s) and reactor internals below the filtration device; reduced pressure drop increase throughout the operation of the reactor, thereby allowing for full or extended run operation; the minimization of additional pressure drop through the reactor, even when the filter bed is completely fouled, i.e., full of contaminant; and, the potential reduction in the amount of grading material required in the top of the catalyst bed, thereby increasing the volume of active catalyst in the reactor.

The present disclosure is not to be limited in terms of the particular embodiments described in this application, which are intended as illustrations of various aspects. Many modifications and variations can be made without departing from its spirit and scope, as may be apparent. Functionally equivalent methods and systems within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, in some cases, the steps described need not be performed in the same sequence discussed or with the same degree of separation. Likewise various steps or features may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive.

Where permitted, all publications, patents and patent applications cited in this application are incorporated by reference herein in their entirety, to the extent such disclosure is not inconsistent with the present invention.

1. A multi-zone filtration device for removing contaminants from a liquid feedstream in a down-flow catalytic hydroprocessing reactor, the filtration device comprising a first filtration zone and a second filtration zone;
the first zone comprising a first zone top cover having inner and outer surfaces, a first zone top cover periphery, and a top cover aperture;
a first zone liquid impervious base plate generally parallel to the top cover having inner and outer surfaces, a base plate periphery, a base plate aperture, and a removable base plate aperture cover, wherein the first zone top cover and base plate are separated by a distance to define a first zone interior volume of the filtration device, and wherein the first zone interior volume comprises a first zone filtration media volume located on top of and adjacent to the first zone base plate inner surface;
a first zone containment barrier to retain filtration media within the first zone filtration media volume on the base plate, located around the perimeter of the base plate and extending from the base plate to the top of the filtration media volume or to the bottom surface of the top cover;
optionally, a first zone base plate aperture containment barrier to retain the filtration media on the base plate, located around the perimeter of the top cover and base plate apertures and extending from the base plate to the top of the filtration media volume or to the inner surface of the top cover;
a first zone support structure for the first zone top cover positioned within the first zone interior volume of the filtration device comprising one or more supports to provide and maintain the separation distance between the top cover and the base plate; and
filtration media contained within the first zone filtration media volume;
wherein, the base plate and the top cover of the first zone, and the top cover and base plate apertures, are centrally located about the same central perpendicular axis, the top cover and the bottom plate having substantially the same areal dimension so that feedstream liquid can flow into the first zone of the filtration device through the top cover and/or through first zone base plate aperture containment barrier, and the base plate aperture cover is sized to prevent liquid flow through the base plate aperture when installed during reactor operation;
the second zone comprising a second zone top cover having inner and outer surfaces, a second zone top cover periphery, a top cover aperture, and a removable top cover aperture cover;
a second zone liquid impervious base plate generally parallel to the top cover having inner and outer surfaces, a base plate periphery, and a base plate aperture, wherein the top cover and base plate are separated by a distance to define a second zone interior volume of the filtration device, and wherein the second zone interior volume comprises a second zone filtration media volume located on top of and adjacent to the second zone base plate inner surface and a flow bypass volume located on top of the second zone filtration media volume and adjacent to the top cover inner surface;
a second zone support structure for the second zone top cover positioned within the second zone interior volume of the filtration device comprising one or more supports to provide and maintain the separation distance between the top cover and the base plate;
a separator positioned between the second zone filtration media volume and the flow bypass volume, wherein the separator is generally thin and parallel to both the second zone top cover and the bottom plate, has top and bottom surfaces, contains the filter media within the second zone filtration media volume, and allows liquid to flow into the second zone filtration media volume during down-flow reactor operation;
a second zone base plate aperture containment barrier to retain filtration media within the second zone filtration media volume on the base plate, located around the perimeter of the base plate aperture and extending from the base plate to the top of the filtration media volume or to the bottom surface of the separator; and,
filtration media contained within the second zone filtration media volume;
wherein, the base plate, the top cover, the separator, and the top cover and base plate apertures of the second zone are centrally located about the same central perpendicular axis as in the first zone, the separator generally having substantially the same areal dimension as the bottom plate, the top cover having a smaller areal dimension than the bottom plate so that feedstream liquid and gas can flow into the second zone inlet between the periphery of the second zone top cover and the periphery of the base plate, and the top cover aperture cover is sized to prevent liquid flow through the top cover aperture when installed during reactor operation.

2. The filtration device of claim 1, wherein the device is a two zone filtration device having one first zone located on top of and adjacent to one second zone, and wherein the device is configured for liquid flow through the first zone followed by liquid and gas flow through the second zone during operation when installed in a down-flow reactor.

3. The filtration device of claim 1, wherein either the first zone base plate is used as the second zone top cover or the second zone top cover is used as the first zone base plate.

4. The filtration device of claim 1, wherein the first zone apertures and the second zone apertures are centrally located about the same perpendicular axis as in the first zone and the second zone and are aligned to provide manway reactor access through the filtration device when installed in a down-flow reactor.

5. The filtration device of claim 1, wherein the first zone includes a base plate aperture containment barrier.

6. The filtration device of claim 1, wherein the first zone containment barrier, the first zone aperture containment barrier, and/or the second zone aperture containment are liquid pervious.

7. The filtration device of claim 1, wherein the device and each of the top covers, base plates, and the separator are generally circular in dimension and are sized to fit horizontally within the top space of a down-flow reactor.

8. The filtration device of claim 1, wherein the first zone has a smaller areal dimension than the second zone to define a first zone outlet area around the perimeter of the first zone through which feedstream liquid flows outward through the first zone containment barrier during operation when installed in a down-flow reactor.

9. The filtration device of claim 1, wherein the second zone top cover has a smaller areal dimension than the second zone base plate to define a second zone inlet area around the perimeter of the second zone through which feedstream liquid and gas enters the second zone and flows inward toward the second zone base plate aperture during operation when installed in a down-flow reactor.

10. The filtration device of claim 1, wherein one or more of the first and/or second zone top cover, base plate, or separator comprises a plurality of sections that together form the respective top cover, the base plate, or the separator, such that the sections may be placed within or removed from a down-flow reactor through a reactor internal access location.

11. The filtration device of claim 1, wherein the support structure of the first zone and/or the second zone comprises a plurality of cross members to provide support for the top cover or sections of the top cover, the separator or sections of the separator, the base plate or sections of the base plate, or a combination thereof.

12. The filtration device of claim 11, wherein the cross members supporting the first zone comprise supports extending from the base plate to the top cover or sections of the top cover.

13. The filtration device of claim 11, wherein the cross members supporting the second zone comprise a top support and an intermediate support between the top and the bottom of the cross member, wherein the top support supports the second zone top cover or sections of the second zone top cover and the intermediate support supports the separator or sections of the separator.

14. The filtration device of claim 1, wherein the first zone top cover and/or the second zone separator comprises a wire, grid, mesh, screen, or perforated metal material or plate that retains the filtration media within the filtration media volume.

15. The filtration device of claim 1, wherein the first zone containment barrier and/or the first and/or second zone base plate aperture containment barrier comprises a wire, grid, mesh, screen, or perforated metal material or plate that retains the filtration media within the filtration media volume and allows feedstream liquid to flow through the filtration media volume during operation when installed in a down-flow reactor.

16. The filtration device of claim 1, wherein the filtration media in the first zone and/or the second zone comprises a particulate filtration absorbent material having a nominal size in the range of about 5 mm to about 20 mm.

17. The filtration device of claim 1, wherein the second zone does not include a containment barrier located around the perimeter of the base plate extending from the base plate to the top of the filtration media volume or to the bottom surface of the top cover, or wherein the filtration media is not contained around the perimeter of the base plate, or a combination thereof.

18. A down-flow catalytic hydroprocessing reactor comprising the filtration device of claim 1.

19. A process for removing contaminants from a liquid feedstream in a down-flow catalytic hydroprocessing reactor, the process comprising passing a feedstream to a down-flow catalytic hydroprocessing reactor through a filtration device installed at the top of the reactor according to claim 1, wherein the liquid feedstream passes through the filtration media contained within the filtration media volume of the first zone and through the filtration media contained within the filtration media volume of the second zone of the filtration device.
